(19) United States
(12) Patent Application Publication
(10) Pub. No.: US 2013/0124584 A1
(43) Pub. Date: May 16, 2013

(54) START PAGE FOR A USER'S PERSONAL MUSIC COLLECTION

(71) Applicants: Owen Daniel Otto, Oakland, CA (US); Brandon Bilinski, San Francisco, CA (US); Paul Joyce, Menlo Park, CA (US)

(72) Inventors: Owen Daniel Otto, Oakland, CA (US); Brandon Bilinski, San Francisco, CA (US); Paul Joyce, Menlo Park, CA (US)

(73) Assignee: Google Inc., Mountain View, CA (US)

(21) Appl. No.: 13/297,611

(22) Filed: Nov. 16, 2011

(51) Int. Cl. G06F 17/30

(52) U.S. Cl. 707/822; 707/E17.102

(57) ABSTRACT

Methods and systems for providing an interface page for a music library are provided. According to one embodiment, a method initiates with retrieving metadata associated with audio files contained in a music library of a user. User-defined interactions with the audio files are parsed from the metadata. The user-defined interactions are analyzed to determine songs, artists, albums, or genres of interest to the user. Then information related to the songs, artists, albums, or genres of interest is retrieved from an information source. The related information is presented on an interface page for accessing the music library.

### BACKGROUND

1. Field of the Invention

The present invention relates to methods, systems, and computer programs for providing a start page for a user's personal music collection.

2. Description of the Related Art

Internet applications have grown tremendously over the years and so have the functionality provided to devices that access those applications. One area that has seen such growth relates to audio file management. As users continue to purchase and store more audio music files on their devices, management of those files becomes ever more important. Commonly, users have music libraries on various devices and those devices are usually backed up from time to time. If a user has more than one device, more synchronization is necessary to ensure that each device has access to the desired music. As users upgrade their devices or lose their devices, added complexities arise in syncing new devices to older music libraries. Many times, the management becomes so extensive that users lose some or most of their libraries.

To address these issues, services are now being provided to allow online cloud storage of their music files. However, improvement is still needed to address various challenges posed by cloud storage and to enable new features for interfacing with a user's music library. It is in this context that embodiments arise.

### SUMMARY

Embodiments of the present invention provide methods, systems, and computer programs for providing an interface page for a music library. It should be appreciated that the present invention can be implemented in numerous ways, such as a process, an apparatus, a system, a device or a method on a computer readable medium. Several inventive embodiments of the present invention are described below.

In one embodiment, a method for providing an interface page for a music library is provided. The method initiates with retrieving metadata associated with audio files contained in a music library of a user. User-defined interactions with the audio files are parsed from the metadata. The user-defined interactions are analyzed to determine an artist of interest to the user. Then information related to the artist of interest is retrieved from an information source. The information related to the artist of interest is presented on an interface page for accessing the music library.

In one embodiment, the user-defined interactions include one or more of a rating, a playcount, a date of addition to the music library.

In one embodiment, the artist of interest is an artist associated with one or more audio files having one of a highest rating within the music library, a highest playcount in the music library, or a most recent date of addition to the music library.

In one embodiment, analyzing the user-defined interactions includes assigning a weight to each of the rating, playcount, and date of addition for a given audio file.

In one embodiment, the information related to the artist of interest includes current news information associated with the artist.

In one embodiment, the method further includes determining a location of the user. In one embodiment, the information related to the artist of interest includes tour or event information based on the location of the user.

In one embodiment, determining the location of the user includes analyzing an IP address associated with the user.

In one embodiment, the method includes accessing a social graph of the user; retrieving and analyzing metadata associated with audio files contained in music libraries of one or more secondary users in the social graph of the user, to determine one or more songs of interest associated with the secondary users; and presenting the songs of interest associated with the secondary users on the interface page for accessing the music library of the user.

In one embodiment, presenting the songs of interest associated with the secondary users includes providing links to access the songs of interest in a music store.

In one embodiment, the method includes determining a secondary artist likely to be preferred by the user based on the artist of interest; and providing a link on the interface page to access music of the secondary artist in a music store.

In another embodiment, a non-transitory computer-readable medium comprising program instructions for providing an interface page for a music library is provided. The program instructions include program instructions for retrieving metadata associated with audio files contained in a music library of a user; program instructions for parsing user-defined interactions with the audio files from the metadata; program instructions for analyzing the user-defined interactions to determine an artist of interest to the user; program instructions for retrieving information related to the artist of interest from an information source; and program instructions for presenting the information related to the artist of interest on an interface page for accessing the music library.

In another embodiment, a system for providing an interface page for a music library is provided. The system includes logic for retrieving metadata associated with audio files contained in a music library of a user; logic for parsing user-defined interactions with the audio files from the metadata; logic for analyzing the user-defined interactions to determine an artist of interest to the user; logic for retrieving information related to the artist of interest from an information source; and logic for presenting the information related to the artist of interest on an interface page for accessing the music library.

Other aspects will become apparent from the following detailed description, taken in conjunction with the accompanying drawings.

### BRIEF DESCRIPTION OF THE DRAWINGS

The invention may best be understood by reference to the following description taken in conjunction with the accompanying drawings.

FIG. 1 illustrates a system diagram for enabling access and playing of music files stored in cloud storage, in accordance with one embodiment of the present invention.

FIG. 2 illustrates how user A utilizes a device 106 (e.g. smart phone) to access his or her music library stored in the cloud music storage (CMS) 116, in accordance with one embodiment of the present invention.

FIG. 3 illustrates how a user may upload music to their cloud-based music library, in accordance with an embodiment of the invention.

FIG. 4A illustrates a system for presenting a start page for a music library, in accordance with an embodiment of the invention.

FIG. 4B illustrates a system for presenting a start page for a music library, in accordance with an embodiment of the invention.

FIG. 5 illustrates the setting of user preferences for determining which information modules to provide for a user, in accordance with an embodiment of the invention.

FIG. 6 illustrates systems facilitating retrieval of news related to an artist or genre of interest, in accordance with an embodiment of the invention.

FIG. 7 illustrates the retrieval of tour or event information related to a specific artist or genre of interest, in accordance with an embodiment of the invention.

FIG. 8 illustrates the operation of the recommendation module in providing recommendations based on the user's music library.

FIG. 9 illustrates the operation of the social information module to provide information about music which a user's friends are accessing, in accordance with an embodiment of the invention.

FIG. 10 illustrates an interface page for accessing a music library, in accordance with an embodiment of the invention.

FIG. 11 illustrates a method for providing an interface page for a music library, in accordance with an embodiment of the invention.

FIG. 12 is a simplified schematic diagram of a computer system for implementing embodiments of the present invention.

### DETAILED DESCRIPTION

The following embodiments describe methods, computer programs, and systems for surfacing auto-generated facts about a music library.

It will be apparent, that the present embodiments may be practiced without some or all of these specific details. In other instances, well known process operations have not been described in detail in order not to unnecessarily obscure the present embodiments.

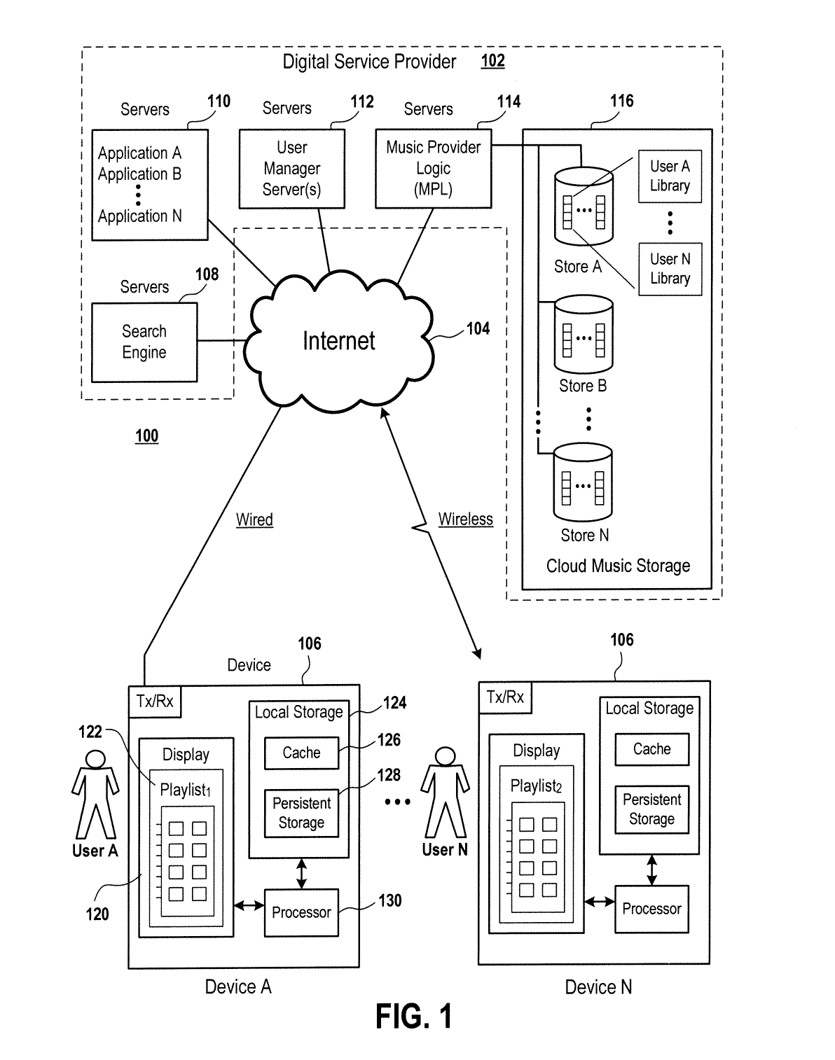

FIG. 1 illustrates a system diagram 100 that defines methods for accessing and playing music files stored in cloud storage, and improving the rate at which playing of a music file response to user selection, is disclosed in accordance with one embodiment of the present invention. The system includes a plurality of servers that are connected to the Internet 104. The plurality of servers and storage are, in one embodiment, part of a digital service provider 102. The digital service provider 102 is a system that can include a plurality of servers that can provide applications, services, digital content, and interconnectivity between systems, applications, users, and social networks. For example, the digital service provider 102 can include a search engine 108, a plurality of servers 110 that provide applications for various business, social, and technology related subject matter, servers that provide user management 112, and servers to provide music related services.

One example digital service provider 102 can be Google Inc., of Mountain View, Calif. Other digital service providers can be more focused to provide only specific services, while others provide a variety of services for access, download, viewing, searching, etc. The content can vary greatly, but is commonly presented in digital format and displayed on monitors or screens of devices, computers, smart phones, tablets, etc.

The servers that provide music related services, in one embodiment, are illustrated by the music provider logic (MPL) 114, which executes over one or more servers that are connected to the Internet 104. The music provider logic 114 is shown connected to cloud music storage 116. Cloud music storage 116 is shown to include a plurality of storage systems, identified as store A, store B, and store N. The various storage systems that hold music data and music metadata, are provided with fast access to the Internet, for providing music data on demand to users requiring access to their music library stored in cloud music storage 116. In one embodiment, users can access the cloud music storage 116 by way of a plurality of devices 106. The plurality of devices can include any type of device having a processor and memory, wired or wireless, portable or not portable. In the example illustrated in FIG. 1, user A is shown to have device 106 (device A). Device 106 is shown to include communication logic for transmitting and receiving data between device 106 and the Internet 104.

The communication logic (Tx/Rx) can include various types of network interface circuitry, radio-communication (e.g. wireless), cell tower communication, or interconnected wiring connected to Internet service providers. Device 106 is also shown to include a display having a screen 120, local storage 124, and a processor 130. Local storage 124 can include cache memory 126, persistent storage 128, and other logic. In this example, device 106 is shown to include graphical icons (e.g., graphical user interfaces GUIs) that represent a play list. The screen 120 can be a touch-screen, or a display typically provided by a flat-panel display, a cathode ray tube (CRT), or other media capable of rendering a display. Still further, device 106 can have its display separate from the device, similar to a desktop computer or a laptop computer. Still further yet, device 106 can be in the form of a smart phone, a tablet computer, or hybrids that provide touch-screen capability in a portable form factor. One example device can include a portable phone device that runs an operating system and is provided with access to various applications (apps) that may be obtained over the Internet, and executed on the local portable device (e.g., smart phone, tablet, laptop, desktop, etc.).

In one embodiment, the user of device 106 can install an application that provides cloud storage of music files, and access to the storage cloud music files from the device 106. Once the user's music files are uploaded to the cloud music storage 116, the user's music files are associated to a library of the user. In one embodiment, a plurality of users can access the same application and can upload their own music files to create their own library, which will be stored in the cloud music storage 116.

Each of such users can then access the cloud music storage 116 through an application on their device 106 to render and play selected music files on their device, when the device 106 has access to the Internet and associated servers of the music providing logic 114 and cloud music storage 116. Accordingly, users can access the music application on their device 106, access all music files stored in cloud music storage 116, arrange music titles in their music library into playlists, add music to the cloud music storage 116, delete music from the cloud music storage 116, and purchase music that is added to the cloud music storage 116. These changes are maintained and managed by the music provider logic 114 and music provider logic 114 will provide access to the various users to their music files stored in the cloud music storage 116, based on their selections during use of the application.

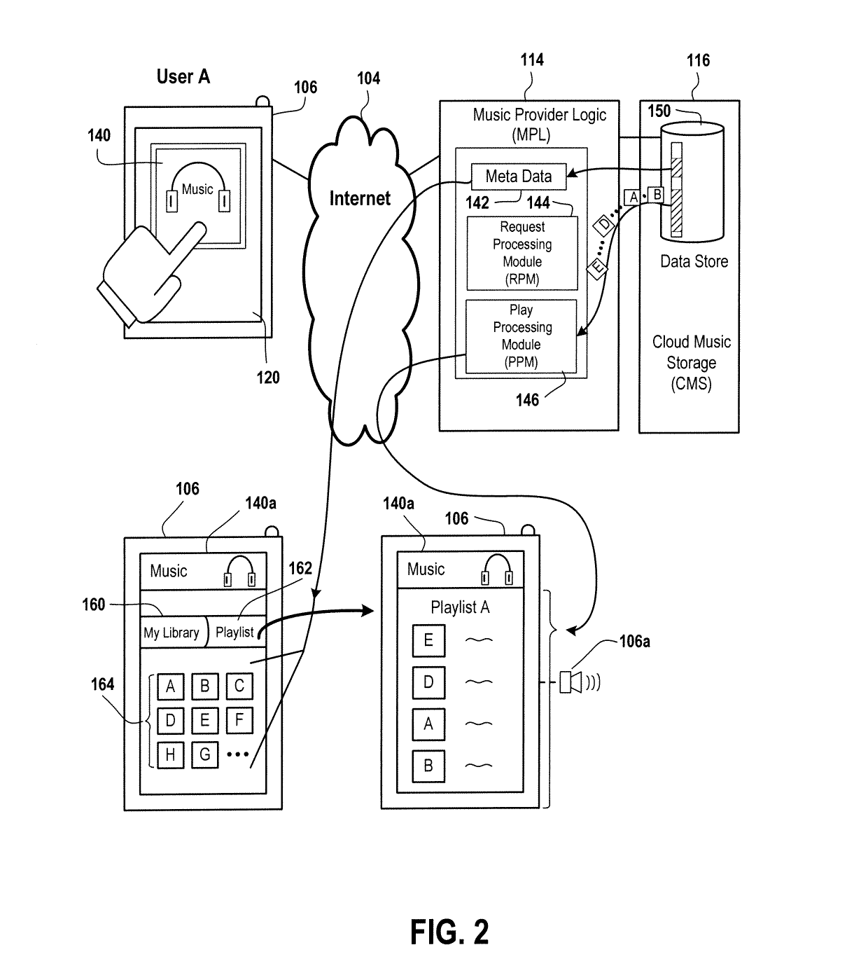

FIG. 2 illustrates how user A utilizes a device 106 (e.g. smart phone) to access his or her music library stored in the cloud music storage (CMS) 116, in accordance with one embodiment of the present invention. As shown, the device 106 will include a screen 120, and associated graphical icons that present a thumbnail of an application 140, associated with a music application. Application 140, as described herein, relates to an application that provides a user with access to his or her music library that has been previously added to the club music storage 116. If the user is a new user to the application 140, the new user can download application 140 to device 106 from at least one server 110 of the digital service provider 102.

Once the application has been downloaded and installed on device 106, the icon representing application 140 will be rendered on the display screen of device 106. Initially, the user will be prompted to select music to add to the cloud music storage 116. The music may be added from files currently maintained by the user on his or her device 106, on other devices of the user such as computers, other smart phone and or tablets, or other storage media. Additionally, the user can add music files that may be part of a music library maintained by another application. The other application may maintain a specific format for the music, and the music can be obtained and translated to standardize music files for addition to the cloud music storage 116.

Once the user has managed his library to add, modify, or adjust the music files present in the cloud music storage 116, the user can access application 140 and various options from graphical user interfaces provided on the screen 120 of device 106. In the illustrated example, device 106 will open application 140 through various graphical user interface screens, such as interface 140a. Interface 140a can include various menus, selection icons, configuration icons, displays, advertisements, buttons, listings, etc. In this example, the interface 140a may include an icon that lists the users library 160, the users play list 162, and music title icons 164. Music title icons can be represented by graphical artwork that represents artwork associated with the various music files present in the users library. The users library is illustrated by title icons 164, shown as A-H.

The title icons 164 are rendered on the screen 120 upon obtaining metadata from the cloud music storage 116, which may be present in data store 150. Music provider logic 114 will include request-processing module 144 that manages the requests and communication between various users applications 140 and the cloud music storage 116. The request processing module (RPM) 144 is also in communication with a play processing module (PPM) 146. In order to render the title icons 164 on the screen of the device 106, the music processing logic 114 will utilize the request processing module 144 to obtain metadata 142 from the data store 150.

The metadata 142 will be the metadata associated with the various music files stored in data store 150 for the requesting user. The metadata 142 provides information regarding each of the titles stored in the cloud music storage 116, and sufficient information to render the title icons 164 on the screen of device 106, and provide text information, duration information, genre information, and other data that describes aspects or characteristics of the music files. One example of metadata is an ID3 tag, which can contain information such as title, artist, album, year, track number, genre, etc. As shown, when the user selects play list 162 on device 106, a play list graphical user interface is shown identifying particular songs that have been arranged by the user.

The playlist A represents various songs that were selected by the user to be part of playlist A. The user can have various playlists, and the selection of playlist A is only provided as one example of a playlist that includes music files that are played in the order E→D→A→B. Once the user selects a corresponding play button or clicks on one of the audio files in the playlist, the music files will begin to play in the order arranged and defined by the user in his or her playlist A.

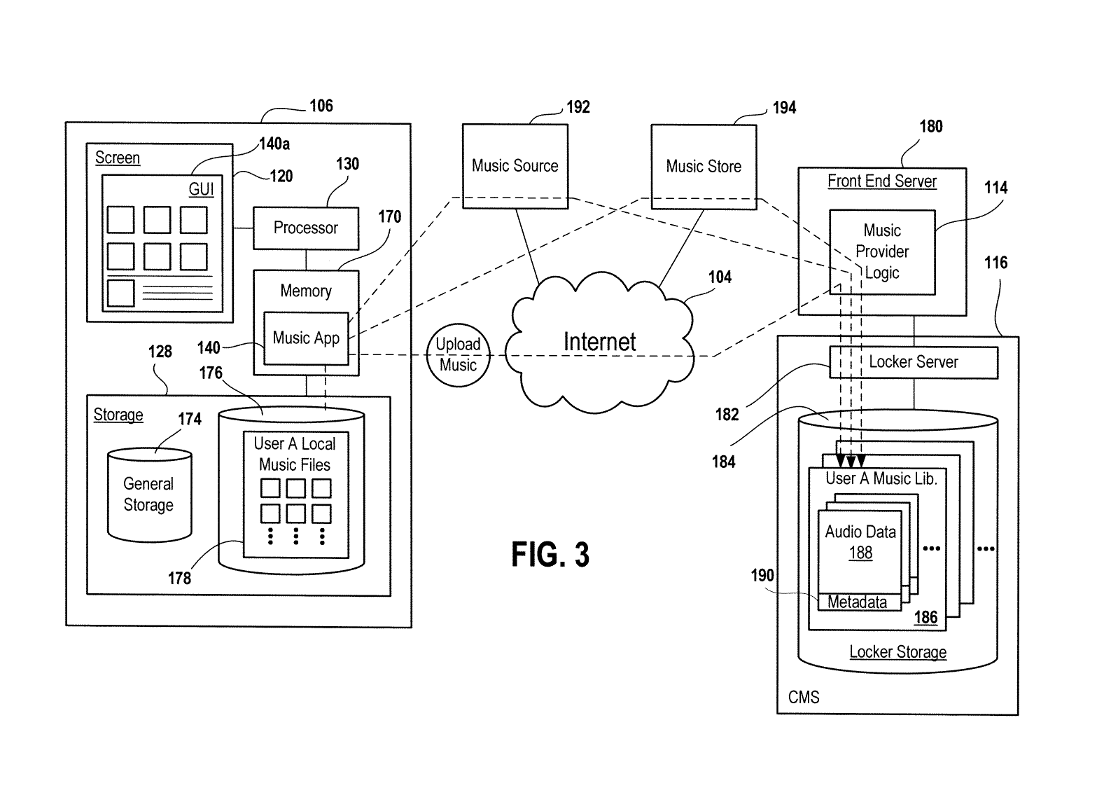

FIG. 3 illustrates how a user A may upload music to their cloud-based music library, in accordance with an embodiment of the invention. As shown, the music application 140 is executed in a memory 170 of the device 106. The device 106 includes persistent storage 128, which contains general storage 174 and local music storage 176. The local music storage 176 includes various music files 178 which the user A has stored on the device 106. The music application 140 provides an interface 140a shown on the display 120 of the device 106, which enables the user A to manually or automatically upload one or more of the music files 178 to the user's music library 186.

In one embodiment, the music application 140 detects the music files 178 and communicates with the music provider logic 114 via the Internet 104. The music provider logic 114 executes on a front end server 180. The music provider logic 114 communicates with a locker server 182, which manages access to a locker storage 184. The locker storage 184 contains various users' individual music libraries, including user A's music library 186. The music library 186 includes various audio files, each of which is defined by audio data 188 and associated metadata 190. Thus, in one embodiment, the music application 140 transmits one or more of the locally stored music files 178 to the music provider logic 144 which accesses the locker server 182 to store the music files within the user's music library 186.

It will be noted that music files from various other sources may also be uploaded to the user's music library 186. For example, music files from an external music source 192 that is available via the Internet 104 can be uploaded to the user's music library 186. In one embodiment, the music application 140 enables the user A to access, listen to, and authorize uploading of a music file from the external source 192. One example of an external music source is an online music store 194, from which the user A may purchase music for downloading to the user's music library. It will be appreciated that in the illustrated embodiment, by purchasing music from the music store 194, the user A causes a music file to be transferred from the music store 194 to the user A's music library 186. This is distinguished from a conventional online purchase where data is transferred to the user's client device. In the presently described embodiment, the data is transferred to a cloud-based storage library, which the user then accesses utilizing a client device 106.

For purposes of the present disclosure, a “song” shall refer to a canonical audio work, whereas an “audio file” or “music file” shall refer to a data file containing audio data that may be read or played so as to reproduce a previously recorded sound. Thus, each particular song is unique, whereas there may be many different types of audio files that encode the same song. A song is typically composed or performed by an artist, and may be part of an album. A typical audio file may have any of various audio file formats, such WAV, MP3, AAC, WMA, FLAC, etc., and may include various types of metadata, such as that contained in ID3 tags. Despite having different meanings in a strict sense, it will be apparent that in many situations, the terms “song” and “audio file” or “music file” may each be accurately applied, or even used interchangeably. A music library consisting of a number of audio files can also be said to contain the various songs for which the audio files encode.

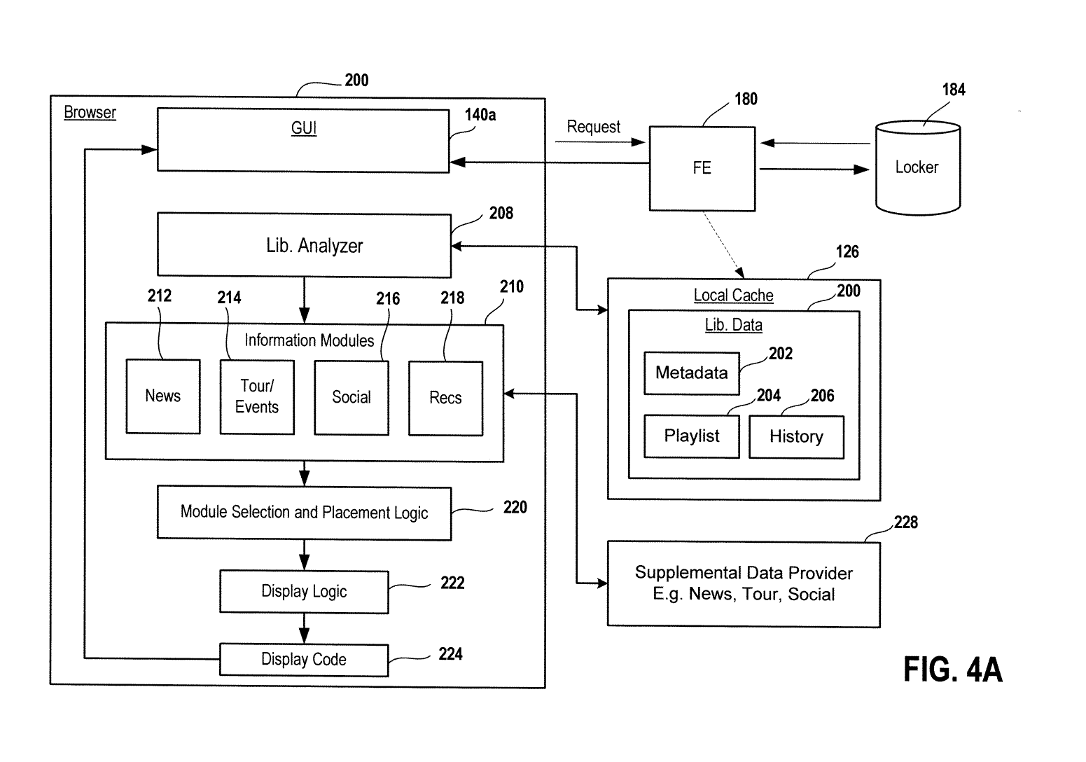

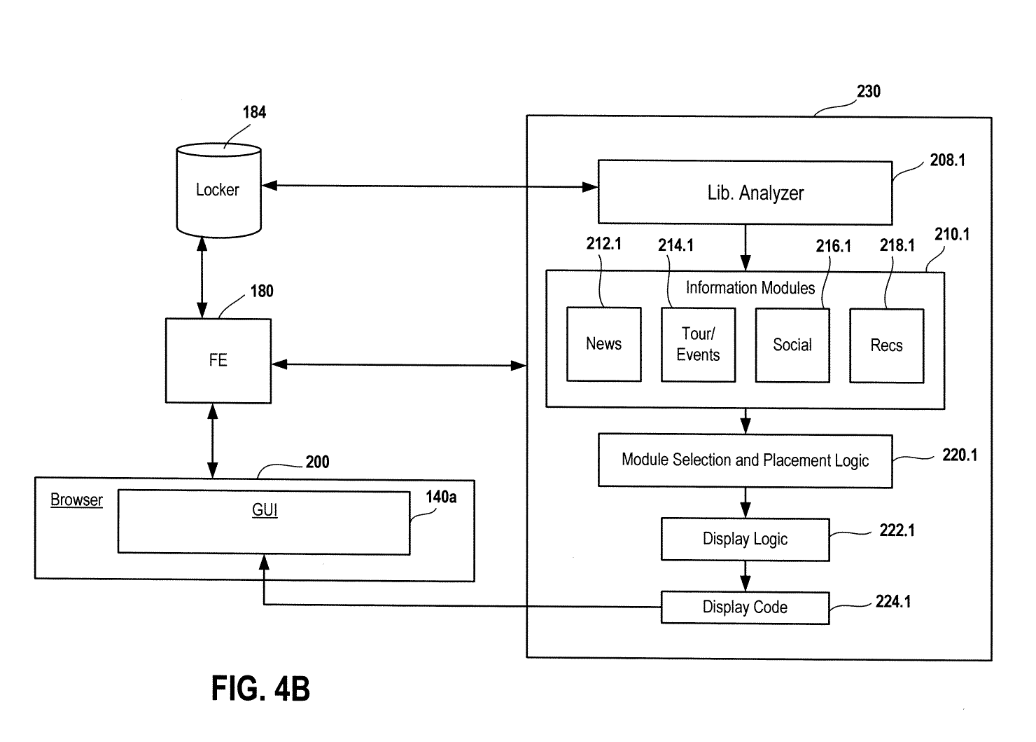

FIG. 4A illustrates a system for presenting a start page for a music library, in accordance with an embodiment of the invention. In one embodiment, the user accesses their music library via a browser application 200 executing on the user's client device. In response to a request to access the user's music library, the front end server 180 provides a web-based interface 140a that is rendered by the browser 200, and which enables the user to access and manage their music library. The request also triggers downloading of library data 200 into the client device's local cache 126. The library data 200 includes various kinds of data relating to the user's music library, and can include metadata 202 from the audio files contained in the user's music library, playlists 204, and history data 206.

Additionally, the request to access the music library triggers downloading of script code (e.g. javascript, AJAX, etc.) to the client device that is configured to present information relating to the user's music library as part of the graphical user interface 140a. In one embodiment, the script code includes a library analyzer 208 configured to perform analysis of the library data 200 to determine an artist or genre of interest to the user. To accomplish this, the library analyzer 208 may parse the metadata 202 for user-defined interactions with the audio files of the music library, such as ratings, playcounts, dates of addition to the library, and other types of data which are indicative of the user's interaction with the music files.

It will be appreciated that in various embodiments, the particular method according to which an artist or genre of interest is determined may vary. For example, in one embodiment, the artists or genres of interest are determined based on the number of songs associated with the artists or genres in the library. For example, those artists or genres having the highest number of songs or albums represented in the library may be determined to be artists or genres of interest.

In another embodiment, the artists or genres of interest are determined based on ratings of songs. For example, those artists or genres having the highest ratings could be determined to be artists or genres of interest. Ratings of various artists or genres may be compared based on average ratings of songs by each of the artists or in each of the genres. Furthermore, the ratings could be weighted according to the number of songs associated with an artist or genre, or other according to other factors.

In another embodiment, the artists or genres of interest are determined based on playcount of songs associated with the artists or genres. For example, the artists or genres of interest may be determined as those artists or genres having the highest total number of song plays, as determined by summing the playcounts of songs associated with each of the artists or genres.

In another embodiment, the artists or genres of interest are determined based on a date of addition to the music library. For example, artists or genres for which representative songs have been most recently added to the library may be determined to be artists or genres of interest.

In another embodiment, the artists or genres of interest could be determined according to which artists or genres have the most songs in the user's music library with the highest ratings.

Additionally, an artist or genre of interest can be determined based on which artists/genres have songs or albums that have been purchased from the store recently.

In still other embodiments, any of the foregoing methods may be synthesized in various ways to determine artists or genres of interest to a user. For example, in one embodiment, the artists or genres of interest are determined based on the number of songs, the ratings, the playcounts, and the dates of addition of songs associated with each of various artists and genres. In one embodiment, weights are assigned to each of these factors. In one embodiment, the weights are based on a profile of the user, which can include various information about the user, such as the user's age, gender, residence, indicated interests, etc.

In one embodiment, the library analyzer 208 determines an artist or genre of interest based at least in part on the user's current or recent listening activity. For example, in one embodiment the artist or genre associated with a song which the user is currently listening to can be determined as an artist of interest. In another embodiment, the user's listening activity within a current session or as represented by a certain number of recent song plays can be analyzed to determine one or more artists or genres of interest.

It will be appreciated that library analyzer 208 can determine multiple artists or multiple genres of interest. In one embodiment, the library analyzer 208 determines a ranked order of artists or genres of interest. A specific ranked order can be determined by scoring each of various artists or genres according to factors as have been described.

While analysis of the music library has been broadly described with reference to determining an artist or genre of interest, the analytical concepts may be extended to determine songs of interest, albums of interest, group types, specific instrumentalists or vocalists, or other musical classifications according to which songs may be classified, compared, or otherwise analyzed. Thus, while several embodiments are specifically described herein with reference to songs, artists or genres only, this is done for ease of description, and not by way of limitation. Those skilled in the art will readily understand that similar concepts may be applied for other kinds of classifications, in accordance with alternate embodiments of the invention.

With continued reference to FIG. 4A, various information modules 210 are provided for determining information that may be presented to the user as part of an interface page for accessing the user's music library. A news information module 212 retrieves news related to artists or genres of interest. Similarly, a tour/events information module 214 retrieves information about tours or events relating to the artists or genres of interest. A recommendations information module 218 provides recommendations based on the user's artists or genres of interest. And a social information module 218 retrieves information about music relating to the user's social graph in a social network. Each of these information modules is described in further detail below. In some embodiments, an information module may communicate with a supplemental data provider 228 so as to request and retrieve information. In other embodiments, it will be appreciated that other information modules may be provided for the purpose of presenting information as part of an interface page for the user's music library.

Module selection and placement logic 220 is provided for selecting which information from the information modules 210 to provide on an interface page for accessing the music library, as well as determining the placement of such information on the interface page. In one embodiment, information modules are selected based on whether they have retrieved any relevant information. For example, if the news information module 212 does not retrieve any relevant news (e.g. within a given recent time period), then it is not selected. Similarly, the tour/events information module 214 might not retrieve any information because it is configured to retrieve only information that is relevant to the geographic vicinity of the user, and thus the tour/events information module would not be selected for display.

In another embodiment, information modules are selected based on how recent their information has been updated. For example, the news information module 212 might only be selected if it retrieves news that has not already been retrieved, or news which is no older than a specified time period. In one embodiment, the logic 220 may select which information to present on a rotating basis, so that information from each information module is presented in turn. This can be based on a timer, a number of refreshes, or other cues to change the selected information. In one embodiment, information modules may be selected based on the user's profile, which can include personal information, indicated preferences, and information determined based on tracking the user's interaction with their music library. In another embodiment, information modules may be selected based on the user's current or recent activity. Any of the foregoing principles for selection of information modules for presentation can be applied alone or in combination to any of various types of information modules. The foregoing examples of information module selection are provided by way of example only and not by way of limitation, as in other embodiments, there may be additional methods for information module selection applied.

Additionally, the logic 220 can be configured to determine the specific placement of information from the selected information modules on the interface page. For example, the interface page may be defined by various interface components, one or more of which is defined to present information from the information modules. When multiple information modules are selected for presentation, then logic 220 may determine the arrangement of their corresponding interface components on the interface page. For example, in one embodiment the arrangement is based on the recency of information, so that interface components which feature information that is more recent is arranged in a more prominent position, such as a top or upper position, than interface components which feature information that is less recent. In other embodiments, the arrangement of interface components can be rotated in a systematic fashion or configured in a random arrangement. In still other embodiments, the arrangement of interface components may be based on the user's profile or recent activity. It will be appreciated that the foregoing examples of methods for determining placement are merely exemplary, as in other embodiments, the placement of interface components may be according to any of various other mechanisms.

Based on the selection and placement of information from information modules as determined by the selection and placement logic 220, display logic 222 generates display code 224 (e.g. HTML), which is rendered to define the display of the information as part of the graphical user interface 140a.

While embodiments of the invention have generally been described with reference to various types of analysis and processing occurring within the context of a browser application, it will be apparent to those skilled in the art that such analysis and processing can occur in the context of any type of general or specific application. Furthermore, embodiments described herein have broadly provided for such functionality to be handled on a client device. However, in other embodiments various portions of the analysis and processing can occur on one or more remote servers. For example, in one embodiment the library analyzer 208, the information modules 210, and the module selection and placement logic 220 can be located on one or more remote servers. In another embodiment, the display logic 222 can also be situated on a remote server. In such an embodiment, the client device would not handle any significant processing required for the determination of information to be presented from the various information modules. Rather, the client device would merely receive display code 224 and render it as part of a graphical user interface.

By way of example, FIG. 4B illustrates one such embodiment of a system for presenting a start page for a music library, wherein the majority of processing occurs remotely. As shown, the front end server 180, in response to receiving a request to access the user's music library, communicates with a start page provider (SPP) 230. The SPP includes a library analyzer 208.1 that analyzes the user's music library to determine audio classifications of interest, such as songs, artists, albums, genres, etc. Various information modules 210.1 retrieve data related to the determined audio classifications of interest, and include news information module 212.1, tour/event information module 214.1, social module 216.1, and recommendations module 218.1. A module selection and placement logic 220.1 determines which information modules to present and their placement on the start page. Display logic 222.1 generates display code 224.1, which is communicated to the browser 200 for rendering as part of the GUI 140a.

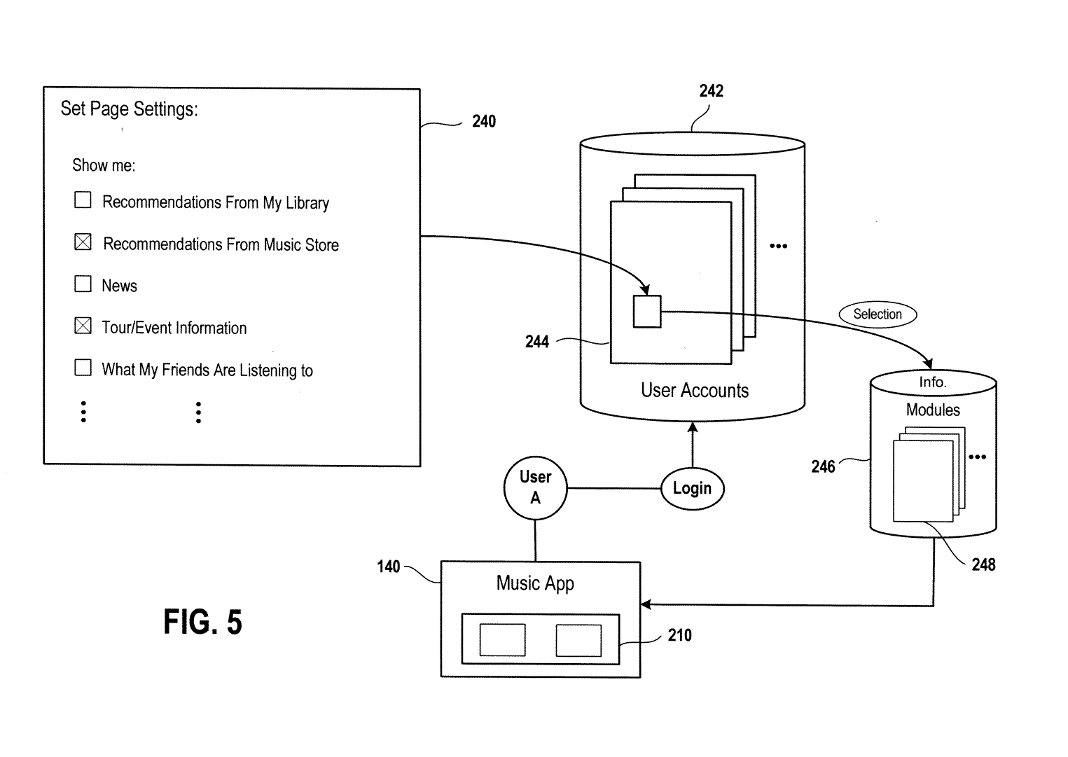

FIG. 5 illustrates the setting of user preferences for determining which information modules to provide for a user, in accordance with an embodiment of the invention. A start page settings page 240 provides an interface by which a user A can designate what type of information to include in a start page for accessing the user's music library. For example, in the illustrated embodiment, the user is able to choose whether or not to include such information as recommendations from the user's music library, recommendations from a music store, news, tour/event information, what the user's friends are listening to, etc. The designations of which types of information to include are saved as part of the user's account 244 in an accounts storage 242.

When user A logs in to his/her music library, the user's account information is accessed, including the designations of which type of information to include in the start page. Based on the stored designations, specific ones of the information modules 248 are selected from information module storage 246. In one embodiment, the selected information modules are included as part of the music application 140, which is accessed by the user A.

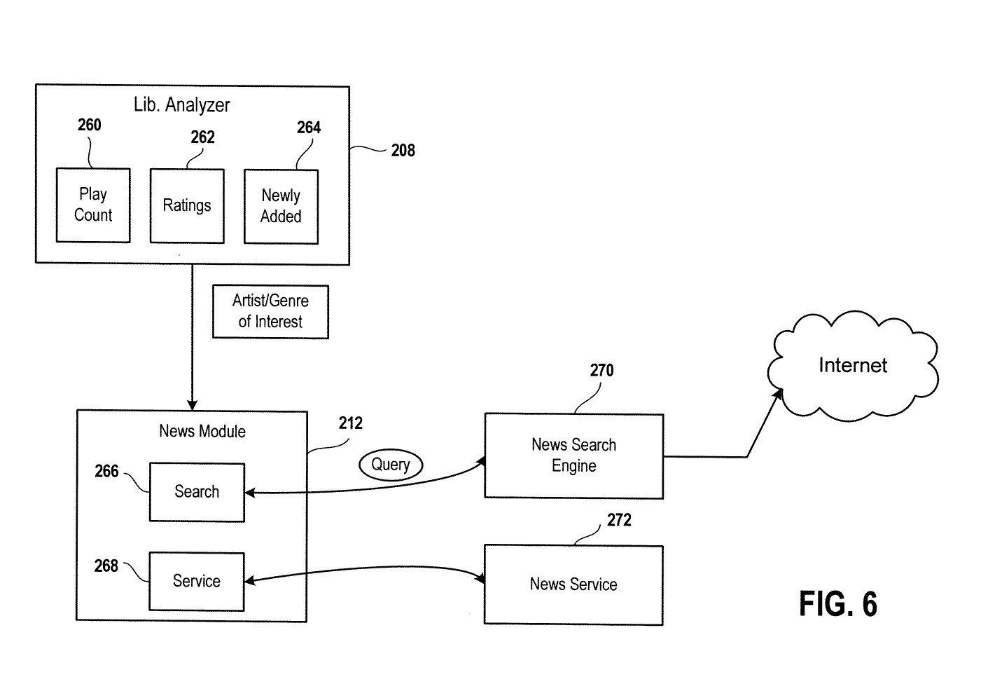

FIG. 6 illustrates systems facilitating retrieval of news related to an artist or genre of interest, in accordance with an embodiment of the invention. As shown, the library analyzer 208 performance analysis of the user's music library. A play count analyzer 260 analyzes the play counts associated with audio files within the user's music library. A ratings analyzer 262 analyzes ratings associated with the audio files within the music library. Likewise, a new addition analyzer 264 analyzes the user's music library to determine whether any new songs have been added to the library. In one embodiment, the new addition analyzer may also be configured to determine songs/albums which have been recently purchased from a music store. Based on analysis of play count, ratings, date of addition or purchase, as well as other possible data relating to the music library, the library analyzer 208 determines an artist or genre of interest to the user. Based on the artist or genre of interest, the news information module 212 retrieves related news information.

The news information module 212 can include a search handler 266, which generates a query that is submitted to a news search engine 270 to search for news related to the artist or genre of interest. The news search engine 271 then searches from various available sources of news, such as may be available via the Internet, and returns results to the search handler 266. It will be apparent that the query generated by the search handler 266 can be customized in various ways, such as by limiting the query to a specified time period so as to search for recent or current news.

Additionally, the news information module 212 can include a service handler 268, which retrieves news related to the artist or genre of interest from a dedicated news service 272. In one embodiment, the news information module 212 can be further configured to parse results received from either or both of the news search engine 270 or the new service 272 to determine which particular news articles to present to the user. The specific news articles selected for presentation can be determined based on various factors such as the user's profile, or the user's current listening activity. Additionally, news articles retrieved by the news information module 212 can be prioritized based on various factors as have already been elucidated.

Furthermore, as has been previously noted, there may be multiple artists or genres of interest, which are presented, in a ranked order. News information module 212 can be configured to retrieve news articles in accordance with the rank ordering of artists and/or genres. For example, if there are no results or insufficient results retrieved for a given artist or genre, then the next highest ranking artist or genre can be selected for retrieval of news.

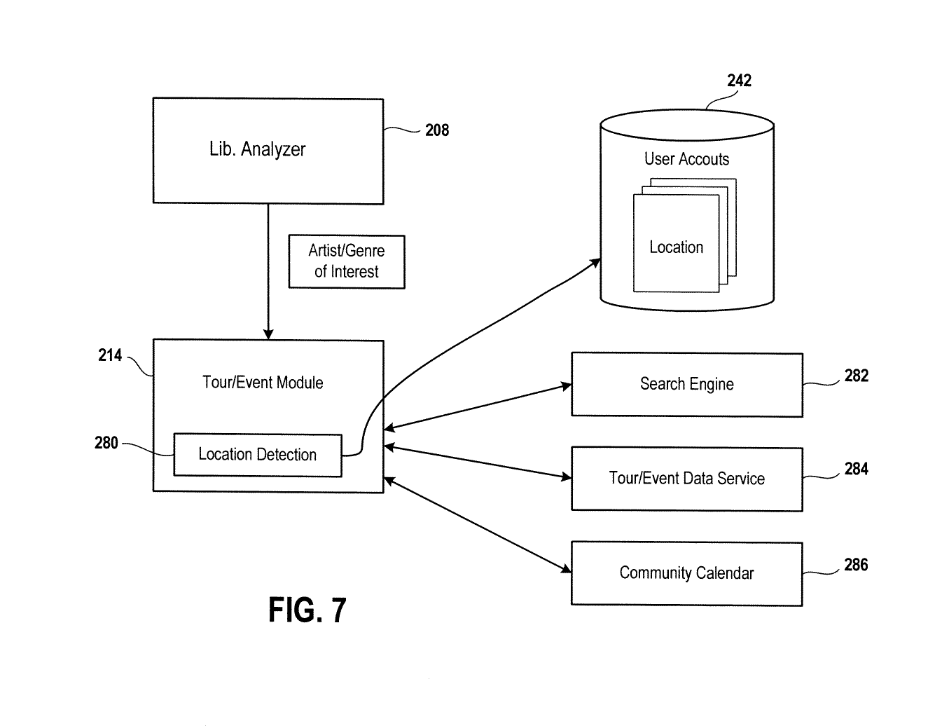

FIG. 7 illustrates the retrieval of tour or event information related to a specific artist or genre of interest, in accordance with an embodiment of the invention. As shown, the library analyzer 208 analyzes the user's music library to determine an artist or genre of interest. The tour or event information module 214 retrieves information regarding tours or events, which are related to the specified artist or genre of interest.

In one embodiment, the event information module 214 includes a location detection module 280 that determines the location of the user. The location detection module 280 can determine the user's location based on information stored as part of the user's account in the user accounts storage 242. In another embodiment, the location detection module 280 can determine the user's location based on alternate methods such as analyzing the user's IP address, or utilizing the Geolocation API. If the music library is being accessed from a smartphone or other GPS enabled device, then GPS information could be utilized to determine the user's location. Based on the user's location, the event information module 214 retrieves information about events related to the artist or genre of interest occurring in a local vicinity of the user's location. To accomplish this, the event information module 214 can retrieve information from various sources such as a search engine 282, a tour or event data service 284, or a community calendar 286.

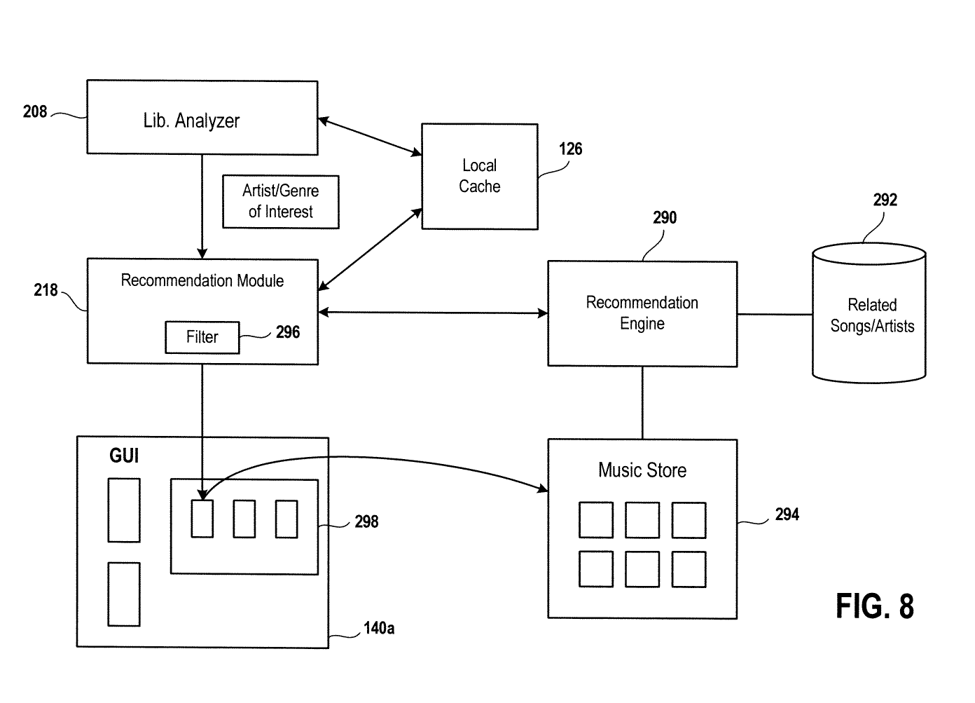

FIG. 8 illustrates the operation of the recommendation module in providing recommendations based on the user's music library. As has been described, the library analyzer 208 determines an artist or genre of interest. Based on the determined artist or genre of interest, the recommendation module 218 provides recommendations of songs or artists to the user as part of the graphical user interface 140a. In one embodiment, the recommendation module 218 accesses a recommendation engine 290 that determines songs or artists that the user may find enjoyable based on the determined artist or genre of interest. In one embodiment, the recommendation engine 290 determines the recommended songs or artists by referencing a related songs or artists storage 292 that stores associations amongst songs or artists. In particular, the recommendation engine 290 can provide are available for purchase from a music store 294.

The recommended artists or songs provided by the recommendation engine 290 are filtered by a filter 296 so as not to present to the user songs that the user already owns. The recommended songs or artists are presented as part of an interface component 298 included in the graphical user interface 140a. In one embodiment, a recommended song or artist presented to the user can also provide a link to the music store 294 so that the user can purchase recommended song or artist and add them to their music library.

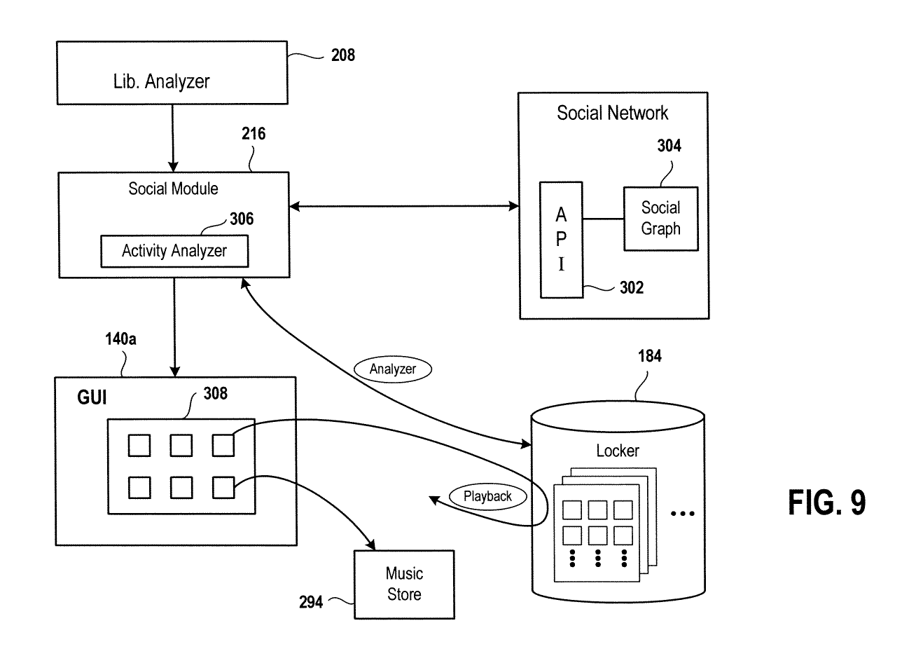

FIG. 9 illustrates the operation of the social information module to provide information about music that a user's friends are accessing, in accordance with an embodiment of the invention. As previously described, the library analyzer 208 determines one or more artists or genres of interest based on analysis of the user's music library. A social information module 216 accesses an API 302 of a social network 300 in order to access a social graph 304 of the user, and determine secondary users in the social graph of the user. For the secondary users within the social graph 304, an activity analyzer 306 analyzes data regarding the secondary users's access activity of their respective music libraries, and determines songs or artists of interest to the secondary users.

In one embodiment, the social information module 216 determines a song of interest for a secondary user within the user's social graph by determining whether the secondary user is currently listening to any music, and if so, what song or artist they are listening to. In another embodiment, a song or artist of interest is determined by analyzing the music library of the secondary user, including analysis of such data as playcount, ratings, date of addition, playlists, etc. In another embodiment, the song or artist of interest is determined by analyzing recently played songs within a specified time period. In one embodiment, if a secondary user is not currently listening to music, then their recent activity within their music library is analyzed to determine a song or artist of interest to the secondary user.

The determined songs or artists of interest to the secondary users are presented to the user as part of an interface component 308 featured on the graphical user interface 140a. In one embodiment, specific secondary users are indicated alongside the songs or artists of interest of the secondary users, so that the user can see which of his or her friends is associated with a particular song or artist of interest. In another embodiment, the activity analyzer 306 determines top songs, top albums, or top artists from across the user's social graph, and these are presented to the user in the interface component 308. If a song is already in the user's library, then the user can access that song from the component 308. If the song is not already in the user's library, then in one embodiment, a link is provided to a music store 294 where the user can preview or purchase the song or the artist's music.

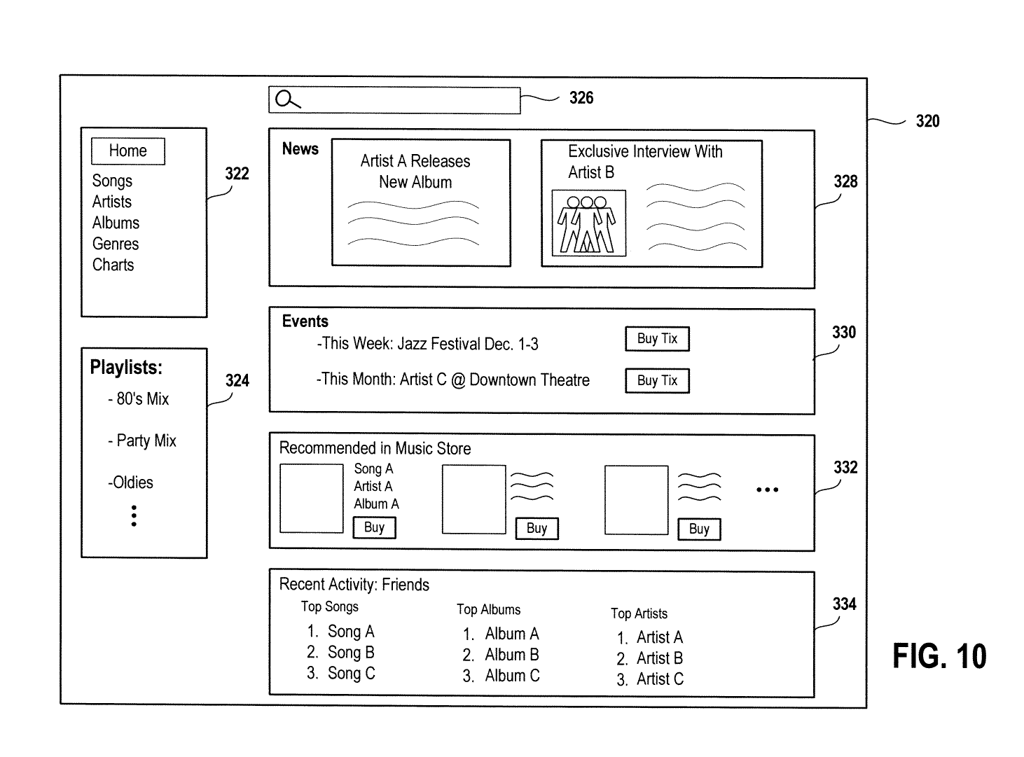

FIG. 10 illustrates an interface page for accessing a music library, in accordance with an embodiment of the invention. The interface page 320 includes various interface components that provide various types of functionality to the user. A navigation panel 322 includes various organizational options for interacting with the user's music library, such as viewing songs, artists, albums, genres, and charts. In the illustrated embodiment, the currently selected option is a home or start page. A playlist panel 324 provides access to various playlists. A search tool 326 enables the user to search within their music library, and can be configured to search other sources of information, such as a music store, or the Internet in general.

A news component 328 displays news relating to artists or genres of interest. In one embodiment, headlines or previews of specific articles are provided in the news component 328, from which the user may access the full version of the articles. In one embodiment, previews of various articles are rotated within the news component 328 so that the user may see a variety of news articles. In one embodiment, the user is able to scroll through the various article previews or headlines, such as by using arrow keys or clicking an arrow or button (not shown). An events component 330 presents information about events or tour information related to artists or genres of interest to the user. The information can be specific to the user's location so as to be more relevant to the user. A recommendations component 332 provides recommendations of songs, albums, or artists from a music store to the user. And a social component 334 presents information based on the musical listening activity of secondary users in the primary user's social graph. These can include listings of top songs, top albums, or top artists based on recent activity of the secondary users.

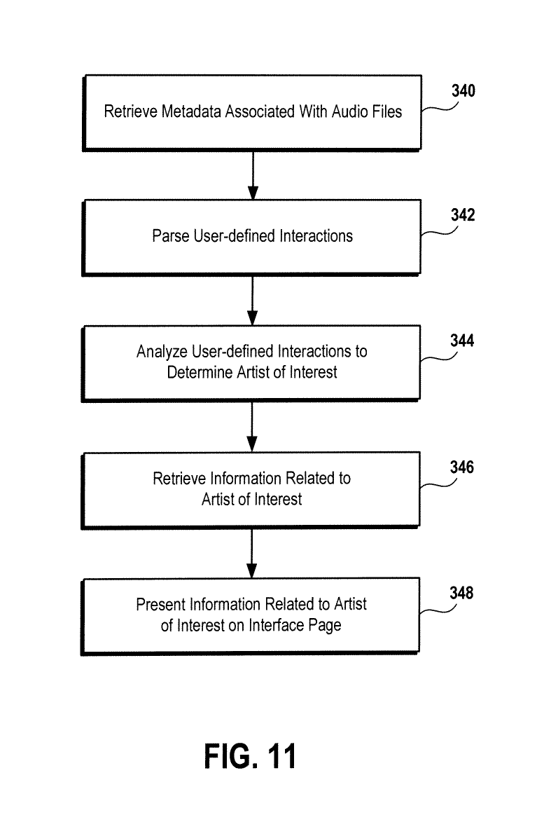

FIG. 11 illustrates a method for providing an interface page for a music library. At method operation 340, metadata associated with audio files contained in a music library of a user is retrieved. At method operation 342, user-defined interactions with the audio files are parsed from the metadata. At method operation 344, the user-defined interactions are analyzed to determine an artist of interest to the user. Then at method operation 346, information related to the artist of interest is retrieved from an information source. At method operation 348, the information related to the artist of interest is presented on an interface page for accessing the music library.

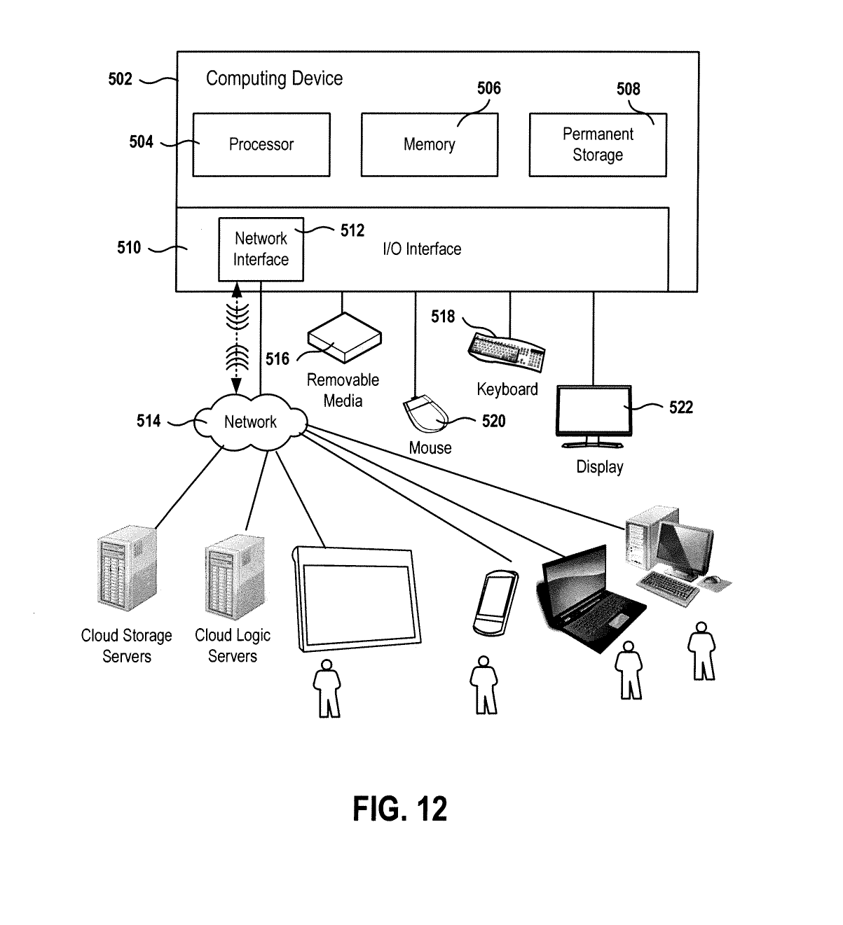

FIG. 12 is a simplified schematic diagram of a computer system 902 for implementing embodiments of the present invention. FIG. 9 depicts an exemplary computer environment for implementing embodiments of the invention. It should be appreciated that the methods described herein may be performed with a digital processing system, such as a conventional, general-purpose computer system. Special purpose computers, which are designed or programmed to perform only one function, may be used in the alternative. The computer system 502 includes a processor 504, which is coupled through a bus to memory 506, permanent storage 508, and Input/Output (I/O) interface 510.

Permanent storage 508 represents a persistent data storage device such as a hard drive or a USB drive, which may be local or remote. Network interface 512 provides connections via network 514, allowing communications (wired or wireless) with other devices. It should be appreciated that processor 504 may be embodied in a general-purpose processor, a special purpose processor, or a specially programmed logic device. Input/Output (I/O) interface 510 provides communication with different peripherals and is connected with processor 504, memory 506, and permanent storage 508, through the bus. Sample peripherals include display 522, keyboard 518, mouse 520, removable media device 516, etc.

Display 522 is configured to display the user interfaces described herein. Keyboard 518, mouse 520, removable media device 516, and other peripherals are coupled to I/O interface 510 in order to exchange information with processor 504. It should be appreciated that data to and from external devices may be communicated through I/O interface 510. Embodiments of the invention can also be practiced in distributed computing environments where tasks are performed by remote processing devices that are linked through a wired or a wireless network.

Embodiments of the present invention can be fabricated as computer readable code on a non-transitory computer readable storage medium. The non-transitory computer readable storage medium holds data that can be read by a computer system. Examples of the non-transitory computer readable storage medium include permanent storage 508, network attached storage (NAS), read-only memory or random-access memory in memory module 506, Compact Discs (CD), Blu-ray™ discs, flash drives, hard drives, magnetic tapes, and other data storage devices. The non-transitory computer readable storage medium may be distributed over a network-coupled computer system so that the computer readable code is stored and executed in a distributed fashion.

Additionally, FIG. 12 shows various types of devices that can connect to the network, such as the Internet. The devices include servers, tablet computers, smartphones, laptops, desktops, etc. The various devices can run operating systems, and the operating systems can vary from manufacturer to manufacturer.

Some, or all operations of the method presented herein are executed through a processor, such as processor 504 of FIG. 12. Additionally, although the method operations were described in a specific order, it should be understood that some operations may be performed in a different order, when the order of the operations do not affect the expected results. In addition, other operations may be included in the methods presented, and the operations may be performed by different entities in a distributed fashion, as long as the processing of the operations is performed in the desired way.

In addition, at least one operation of some methods performs physical manipulation of physical quantities, and some of the operations described herein are useful machine operations. Embodiments presented herein recite a device or apparatus. The apparatus may be specially constructed for the required purpose or may be a general purpose computer. The apparatus includes a processor capable of executing the program instructions of the computer programs presented herein.

Although the foregoing embodiments have been described with a certain level of detail for purposes of clarity, it is noted that certain changes and modifications can be practiced within the scope of the appended claims. Accordingly, the provided embodiments are to be considered illustrative and not restrictive, not limited by the details presented herein, and may be modified within the scope and equivalents of the appended claims.

What is claimed is:

1. A method for providing an interface page for a music library, comprising:
retrieving metadata associated with audio files contained in a music library of a user;
parsing user-defined interactions with the audio files from the metadata;
analyzing the user-defined interactions to determine an artist of interest to the user;
retrieving information related to the artist of interest from an information source;
presenting the information related to the artist of interest on an interface page for accessing the music library.

2. The method of claim 1, wherein the user-defined interactions include one or more of a rating, a playcount, a date of addition to the music library.

3. The method of claim 2, wherein the artist of interest is an artist associated with one or more audio files having one of a highest rating within the music library, a highest playcount in the music library, or a most recent date of addition to the music library.

4. The method of claim 2, wherein analyzing the user-defined interactions includes assigning a weight to each of the rating, playcount, and date of addition for a given audio file.

5. The method of claim 1, wherein the information related to the artist of interest includes current news information associated with the artist.

6. The method of claim 1, further comprising,
determining a location of the user;
wherein the information related to the artist of interest includes tour or event information based on the location of the user.

7. The method of claim 6, wherein determining the location of the user includes analyzing an IP address associated with the user.

8. The method of claim 1, further comprising,
accessing a social graph of the user;
retrieving and analyzing metadata associated with audio files contained in music libraries of one or more secondary users in the social graph of the user, to determine one or more songs of interest associated with the secondary users;
presenting the songs of interest associated with the secondary users on the interface page for accessing the music library of the user.

9. The method of claim 8, wherein presenting the songs of interest associated with the secondary users includes providing links to access the songs of interest in a music store.

10. The method of claim 1, further comprising,
determining a secondary artist likely to be preferred by the user based on the artist of interest;
providing a link on the interface page to access music of the secondary artist in a music store.

11. A non-transitory computer-readable medium comprising program instructions for providing an interface page for a music library, including:
program instructions for retrieving metadata associated with audio files contained in a music library of a user;
program instructions for parsing user-defined interactions with the audio files from the metadata;
program instructions for analyzing the user-defined interactions to determine an artist of interest to the user;
program instructions for retrieving information related to the artist of interest from an information source;
program instructions for presenting the information related to the artist of interest on an interface page for accessing the music library.

12. The non-transitory computer-readable medium of claim 11, wherein the user-defined interactions include one or more of a rating, a playcount, a date of addition to the music library.

13. The non-transitory computer-readable medium of claim 11, wherein the information related to the artist of interest includes current news information associated with the artist.

14. The non-transitory computer-readable medium of claim 11, further comprising,
program instructions for accessing a social graph of the user;
program instructions for retrieving and analyzing metadata associated with audio files contained in music libraries of one or more secondary users in the social graph of the user, to determine one or more songs of interest associated with the secondary users;
program instructions for presenting the songs of interest associated with the secondary users on the interface page for accessing the music library of the user.

15. The non-transitory computer-readable medium of claim 11, further comprising,
program instructions for determining a secondary artist likely to be preferred by the user based on the artist of interest;
program instructions for providing a link on the interface page to access music of the secondary artist in a music store.

16. A system for providing an interface page for a music library, comprising:
logic for retrieving metadata associated with audio files contained in a music library of a user;
logic for parsing user-defined interactions with the audio files from the metadata;
logic for analyzing the user-defined interactions to determine an artist of interest to the user;
logic for retrieving information related to the artist of interest from an information source;
logic for presenting the information related to the artist of interest on an interface page for accessing the music library.

17. The system of claim 16, wherein the user-defined interactions include one or more of a rating, a playcount, a date of addition to the music library.

18. The system of claim 16, wherein the information related to the artist of interest includes current news information associated with the artist.

19. The system of claim 16, further comprising,
logic for accessing a social graph of the user;
logic for retrieving and analyzing metadata associated with audio files contained in music libraries of one or more secondary users in the social graph of the user, to determine one or more songs of interest associated with the secondary users;
logic for presenting the songs of interest associated with the secondary users on the interface page for accessing the music library of the user.

20. The system of claim 16, further comprising,
logic for determining a secondary artist likely to be preferred by the user based on the artist of interest;
logic for providing a link on the interface page to access music of the secondary artist in a music store.
